(19) United States
(12) Patent Application Publication
(10) Pub. No.: US 2004/0250795 A1
(43) Pub. Date: Dec. 16, 2004

(54) Managing fuel volume change in fuel rail

(75) Inventors: Kathleen Stroia, Dester, MI (US); Stephen Kempfer, Canton, MI (US); DeQuan Yu, Ann Arbor, MI (US); Ross D. Pursifull, Dearborn, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/778,377

(22) Filed: Feb. 13, 2004

Related U.S. Application Data
(60) Provisional application No. 60/477,469, filed on Jun. 10, 2003.

(51) Int. Cl. F02M 1/00

(52) U.S. Cl. 123/447; 123/467

(57) ABSTRACT

A fuel volume accumulator is provided to hold rail pressure for hot engine restart and then reduce fuel pressure when the engine is off thereby minimizing evaporative emissions during diurnal cycles by preventing pressure build up as a temperature of a fuel system rises. The fuel volume accumulator comprises a fuel inlet body, and a moving element adapted to communicate with an inner surface of the fuel inlet body to define a fuel chamber. The fuel chamber is adapted to expand with substantially minimal pressure resistance until the extent of its volume is encountered. The fuel inlet body is in open communication at a first end with a fuel pump via a check valve and a fuel rail via an orifice which restricts fuel flow to substantially maintain a quick fuel rail re-pressurization.

This application claims the benefit of U.S. Provisional Application No. 60/477,469, filed Jun. 10, 2003.

### BACKGROUND

The present invention relates generally to fuel delivery systems, and more particularly to a fuel volume in a fuel rail.

EPA and California Air Resources Board (CARB) emissions standards are becoming increasingly stringent with a phase-in of the California Level II and Federal Tier II standards. The California level II standard focuses on fleet average NMOG (Non-Methane Organic Gas) for car manufacturers, and Tier II standard focuses on NOx (Nitrogen Oxide) emissions. Both the Level II and Tier II evaporation standards are designed to substantially lower emissions from the prior standard levels. Thus, these and future standards would affect every automotive vehicle and every major auto manufacturer, effectively the entire auto industry. As such, improvements in the fuel system to reduce tailpipe and evaporation emissions are desired. In general, emissions categories include evaporative, tailpipe, incidental, and re-fueling emissions. Further, the evaporative emissions typically encompass engine-off diurnal losses and running losses.

Pressure accumulators are known in the industry simply as accumulators. Typically, a pressure accumulator's function is to maintain a substantially constant pressure for volume changes. Pressure accumulators have been added into fuel injection systems over the years to attempt to provide a nearly constant pressure during fuel injection events that would otherwise temporarily lower rail pressure during injection and before the fuel pump could make up the lost fuel. The present invention does not attempt to describe a pressure accumulator, but rather a volume accumulator to be used in fuel delivery systems. A fuel volume accumulator's purpose may be to drop fuel pressure quickly as soon as the liquid volume is reduced through thermal contraction. The typical pressure accumulator (used in many industries) and the present volume accumulator have radically different volume versus pressure curves. For the purposes of this specification and the claims, when an accumulator is referred to, it is the novel volume accumulator, rather than the industry-common pressure accumulator.

A prior art search revealed U.S. Pat. No. 4,893,472, which relates to a hydraulic clutch reservoir. The '472 hydraulic clutch reservoir includes a volume accumulator. The '472 volume accumulator is applied to a substantially different vehicle system, and is further purposely pressurized to the point where it supports no further volume expansion. As such, the clutch reservoir accumulator in its current use is specifically designed to avoid that volume expansion condition, so that it can maintain a particular function. The particular function is to prevent hydraulic fluid contamination while maintaining reservoir pressure at substantially atmospheric pressure.

Restoring fuel rail (a.k.a. fuel manifold) pressure quickly at or before key-on is essential for a fast restart, but high fuel pressure during key-off causes injector leakage and emission issues due to the leakage. Typical fuel injection pressure remains high after key-off and is also high during diurnal heating of the vehicle.

Upon engine key-off, the vehicle fuel delivery system (fuel rail, line, and filter) may increase in temperature due to “soaking” in its hot engine compartment, but then it cools toward ambient temperature, and a vacuum may be created therein. As the vacuum is created within the fuel delivery system, vapor and/or liquid fuel may be drawn into the fuel system's volume. With the added volume (mass) in the system and upon diurnal warming, the fuel delivery system re-pressurizes. Typically, a fuel rail temperature immediately after engine-off is higher than the temperature experienced during diurnal cycles. The re-pressurization causes engine-off fuel injector leakage into an intake manifold, which exacerbates evaporative emissions. Fuel injector leakage typically occurs because the fuel delivery system remains or becomes pressurized after the engine is turned off. When the fuel remains or becomes pressurized, fuel leaks from various components in the fuel delivery system. One common source of leakage is through the fuel injectors, which are used in most automotive fuel systems. Fuel can also leak by permeation through various joints in the fuel delivery system.

Fuel leakage is particularly exacerbated by diurnal temperature cycles. During a typical day, the temperature rises to a peak during the middle of the day. In conjunction with this temperature rise, fuel trapped in the system adjoining the fuel injectors expands, thus the pressure in the fuel delivery system also increases, which results in leakage through the fuel injectors and other components. This temperature cycle repeats itself each day, thus resulting in a repeated cycle of fuel leakage and evaporative emissions.

When the engine is off, the fuel rail should remain full of fuel to be ready for the next engine restart, which minimizes fuel rail re-pressurization time. However, for practical reasons, the fuel rail may not remain entirely full and a vapor space may fill the remaining volume. Typically, a fuel pump flow rate compensates only adequately for the vapor space so that the re-pressurization time is slightly increased.

When the engine is running, the volume accumulator is fully filled thus allowing pressure to build to 40 psi (for example). When the engine is off and after the fuel cools several degrees, the fuel's contraction results in the fuel pressure dropping quickly to near zero gauge pressure, but not below. This may be crucial because if it were allowed to go to a vacuum, the fuel system would likely ingest fuel or air and on subsequent diurnal heating re-pressurize.

In present designs, engine-off fuel rail pressure varies between limits set by an over pressure relief valve (e.g. opens at differential pressures greater than +55 psi) and a flow check valve (e.g. opens at differential pressures below than −2.5 psi). When the fuel pressure is positive, fuel may leak out. When the fuel pressure is negative air may leak in through the injectors. When the fuel pressure is very negative, the in-tank check valve typically opens and liquid fuel, fuel vapor, or air may be drawn in. The fuel injector leakage may contribute to a failing of evaporative emission regulations, and air ingestion through the injector while the rail is at a vacuum may degrade re-pressurization time. To minimize engine-off injector leakage, the fuel rail may be de-pressurized when the engine is off. Fuel rail depressurization schemes may involve expelling a thermally expanding fuel that may otherwise cause a pressure increase, and thereby fuel leakage. However, these schemes may retrieve fuel to accommodate for a resulting thermal contraction.

Typically, one is not able to lower fuel temperature, raise barometric pressure, or alter fuel composition in the fuel delivery system. Given these constraints, the fuel rail's liquid fuel has a minimum fuel pressure that corresponds to the fuel's vapor pressure. Vapor pressure exists when the fuel rail contains both fuel liquid and fuel vapor (but no air). When the fuel system is shut off at a temperature higher than a highest temperature reached within the fuel delivery system during the diurnal cycle, diurnal re-pressurization would not occur unless additional mass is drawn into that system. If the formation of this vacuum can be prevented, additional mass cannot be drawn in. A rigid system with no leaks forms a vacuum upon cooling. That vacuum is equal to the fuel's vapor pressure if it has no air in it. Eliminating the leak elements is not an option. However, preventing the vacuum is the invented solution. The invented method prevents vacuum formation by plumbing a volume accumulator into the system.

In view of the above discussed problems, it would be advantageous to provide a fuel delivery system that holds fuel rail pressure for hot restart and maintains the fuel rail filled with liquid fuel to minimize fuel rail re-pressurization time duration, while reducing engine-off fuel rail pressure to minimize injector leakage, and consequently evaporative emissions.

### BRIEF SUMMARY

The present invention is defined by the following claims. This description summarizes some aspects of the present embodiments and should not be used to limit the claims.

A fuel volume accumulator is provided to hold rail pressure for hot engine restart and then reduce fuel pressure when the engine is off thereby minimizing evaporative emissions during diurnal cycles by preventing pressure build up as the temperature of the fuel system rises. One embodiment of the fuel volume accumulator comprises a fuel inlet body, and a valve (moving) element adapted to communicate with the fuel inlet body to define a fuel chamber. The fuel chamber is adapted to expand with substantially minimal pressure resistance until an extent of its volume is encountered. The fuel inlet body is in open communication at a first end with a fuel rail via an orifice which restricts fuel flow to substantially maintain a quick fuel rail re-pressurization.

One advantageous aspect of the fuel accumulator is that it can be employed as an inexpensive passive vacuum prevention device without the need for electronics or a control system. Further aspects and advantages of the invention are described below in conjunction with the present embodiments

### BRIEF DESCRIPTION OF SEVERAL VIEWS OF THE DRAWINGS

The invention, together with the advantages thereof, may be understood by reference to the following description in conjunction with the accompanying figures, which illustrate some embodiments of the invention

FIG. 1 is a schematic of an electronic returnless fuel delivery system (ERFS) with an embodiment of the invented fuel accumulator prior to engine key-off;

FIG. 2 is a schematic of the fuel delivery system of FIG. 1 after engine key-off and the fuel has thermally contracted;

FIGS. 3a-3d are graphs showing a diurnal temperatures and pressure cycles both with and without the invented fuel accumulator;

FIG. 4 is a graph showing fuel pressure versus temperature and the liquid-vapor curves of typical automotive fuels;

FIG. 5 is a schematic of a fuel delivery system with an embodiment of the invented fuel accumulator prior to engine key-off;

FIG. 6 is a schematic of the fuel delivery system of FIG. 5 after engine key-off;

FIG. 7 is a graph of a volume vs. pressure steady state characteristic of the invented fuel volume accumulator;

FIG. 8 is a side cross sectional view of another embodiment of a fuel accumulator having a dome shaped flexible membrane;

FIGS. 9a and 9b are side cross sectional views of another embodiment of a fuel accumulator having a radially collapsible moving element;

FIGS. 10a and 10b are side cross sectional views of another embodiment of a fuel accumulator having a radially collapsible moving element;

FIG. 11a and 11b are drawings of another embodiment of a fuel accumulator having an axially collapsible moving element;

FIG. 12 is a side cross sectional view of another embodiment of a fuel accumulator having a constrained moving element that may depend on material stretching instead of material bending or folding;

FIG. 13 is a side cross sectional view of another embodiment of a fuel accumulator having a piston/spring combination as a moving element; and

FIG. 14 is a schematic of a mechanical returnless fuel delivery system (MRFS) with another embodiment of the invented fuel accumulator prior to engine key-off.

### DETAILED DESCRIPTION

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” object is intended to denote also one of a possible plurality of such objects.

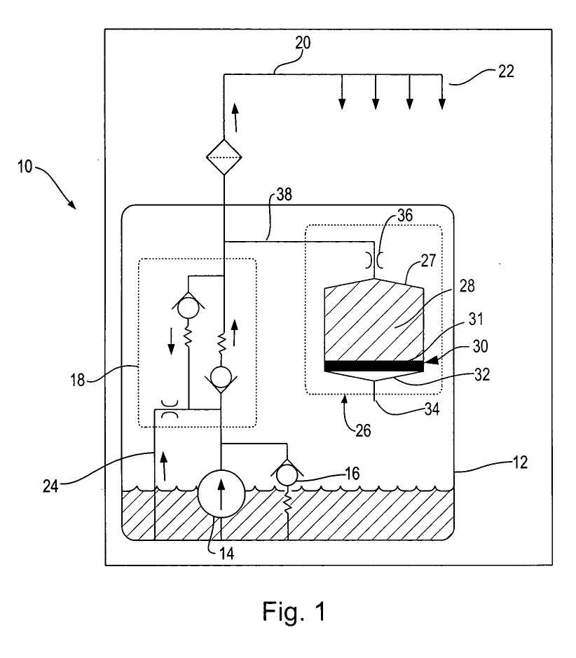

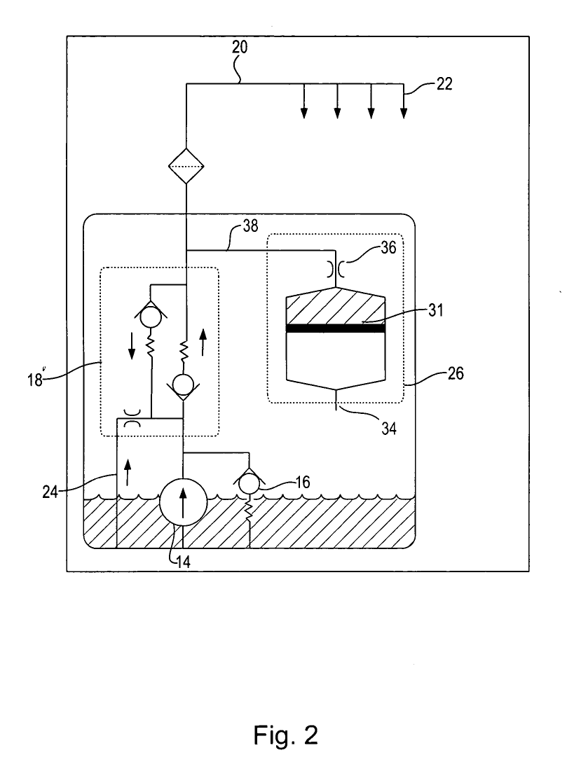

Referring to FIGS. 1 and 2, a fuel delivery system 10 is shown. The fuel delivery system 10 is representative of typical fuel delivery systems used on automotive vehicles and includes a fuel tank 12, a fuel pump 14, a pump pressure relief valve 16, a parallel pressure relief valve (PPRV) 18, a fuel rail 20, and a series of fuel injectors 22. A typical parallel pressure relief valve (PPRV) consists of a 2.5 psi check valve and a 55 psi pressure relief valve. As those skilled in the art will readily appreciate, during operation the fuel pump 14 supplies fuel to the fuel manifold, or fuel rail 20, through the parallel pressure relief valve 18. The fuel is then injected into the intake manifold (not shown) of the engine through the fuel injectors 22. When the automotive vehicle is turned off, the fuel is retained in the fuel rail 20 by the check valve within the parallel pressure relief valve 18. As described above, the pressurized fuel in the fuel rail 20 can result in undesirable fuel leakage through the fuel injectors 22, which results in evaporative emissions.

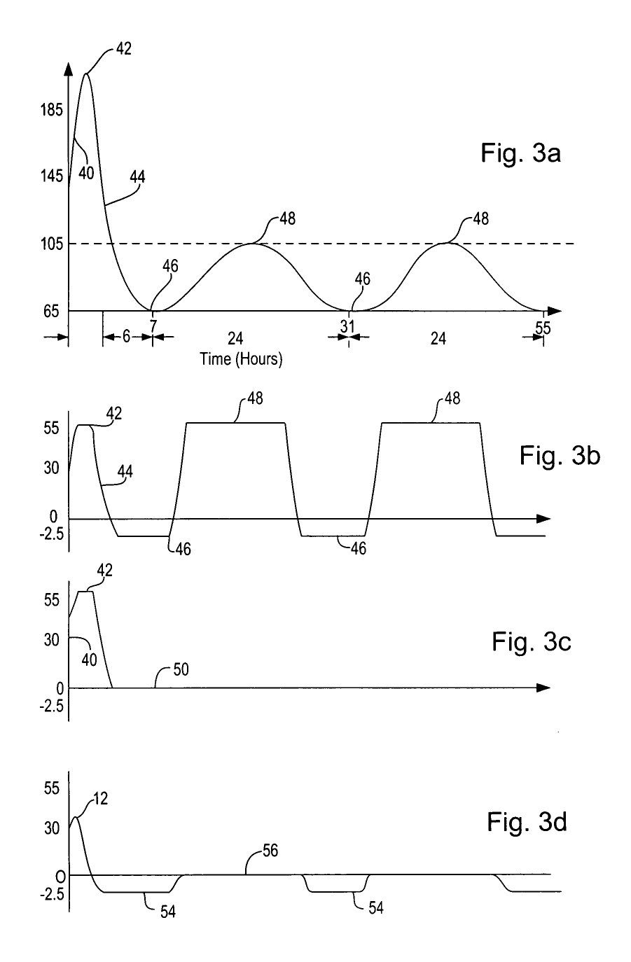

As shown in FIG. 3a, fuel pressure buildup and leakage are typically exacerbated by diurnal temperature cycles. Prior to engine key-off, the fuel pressure is maintained at about 40 to 80 psi above the intake manifold pressure by the fuel pump 14 and the temperature of the fuel rail 20 typically stays at about 195° F. (40). Immediately after engine key-off, the temperature (and thus the fuel rail pressure) increases slightly due to the fact that the cooling systems of the automotive vehicle are no longer running (42). The temperature of the fuel rail 20 then slowly cools and the pressure in the fuel rail 20 consequently falls along with the temperature decrease (44).

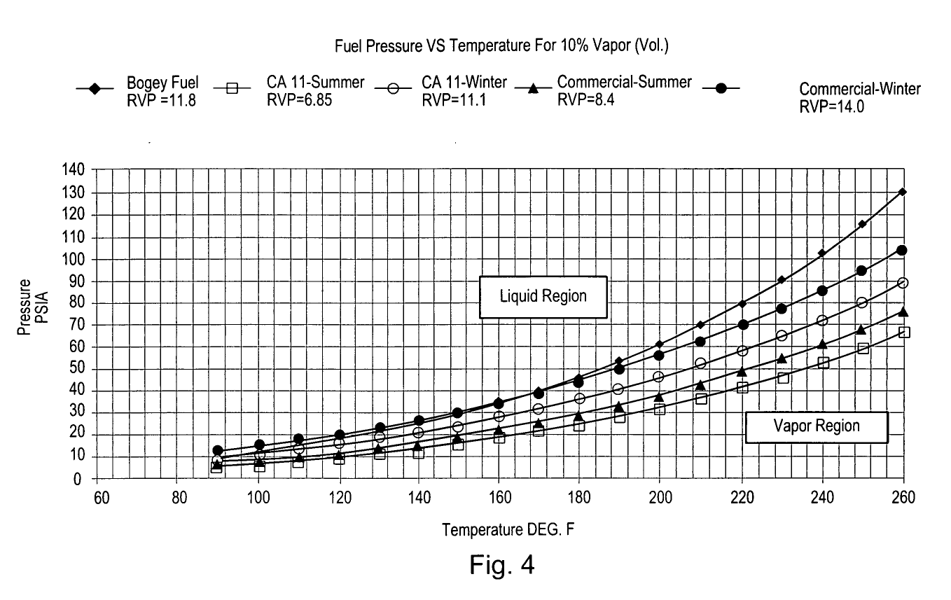

Referring to FIG. 4, pressure versus temperature characteristics of typical automotive fuels and the resulting liquid-vapor curves are shown. The pressure and temperature curves indicate that liquid and vapor coexist. These curves are referred to as liquid-vapor curves. As indicated in FIG. 4, the area above each liquid-vapor curve represents pressure-temperature combinations at which various fuels are in an entirely liquid state. Thus, if there is a vapor space in the system, the pressure is determined by fuel temperature and fuel composition (i.e., the fuel type), assuming a single fuel temperature.

After engine key-off, the volume of the fuel begins to contract while cooling down. As shown in FIG. 1, additional fuel may be drawn up or retrieved toward the fuel rail 20 to compensate for the contracting fuel, from either the fuel pump 14 or a fuel line 24 which terminate at the bottom of the fuel tank 12. However, if the fuel line 24 terminates above the bottom of the fuel tank 12, fuel vapor (or air) may be drawn up into the fuel rail 20 instead. When the diurnal cycle is at a minimum temperature during the night (46), the fuel rail temperature reaches a minimum value (typically 65° F.). Consequently, the fuel rail pressure reaches a corresponding minimum pressure (typically limited to −2.5 psi by the check valve in the parallel pressure relief valve 18) (46).

As part of the diurnal cycle, the fuel rail temperature begins to increase again during daytime warming, after having reached the minimum value during the night. Thus, the pressure in the fuel rail 20 increases as the temperature of the fuel rail 20 increases, until the temperature and pressure reach a maximum (typically 105° F.), which usually occurs in the middle of the day (48). The pressure increase that occurs during the diurnal cycle causes conventional fuel delivery systems to leak fuel through the fuel injectors 22, thereby contributing to evaporative emissions. This fuel leak is repeated during each diurnal cycle until the automotive vehicle is restarted.

According to the present invention, fuel leakage and evaporative emissions can be minimized by adding a vacuum prevention device 26 to the fuel delivery system 10. As shown in FIG. 1, the vacuum prevention device 26 is a fuel volume accumulator or an expansion/contraction tank (ECT). The fuel accumulator 26 consists of a fuel inlet body 27, a valve (moving) element 30 and a cover 32. The fuel inlet body 27 is connected to a fuel input 38 via an orifice 36. The fuel input 38 is in open communication with the fuel pump 14 via the PPRV 18 and with the fuel rail 20. The valve element 30 has a flexible membrane 31, which is surrounded with a frame portion (not shown). The flexible membrane 31 may be an elastomeric diaphragm or the like. Further, the frame portion (not shown) of the flexible membrane 31 is adapted to communicate with an inner surface of the inlet body 27, such as a seal grove for example (not shown), for sealing purposes. The cover 32 has an open top end and a bottom end, with the bottom end having a vent hole 34. The open top end of the cover is adapted for securing to the second end of the inlet body 27, by welding them together for exampling, thereby creating a cavity. As such, the flexible membrane 31 produces an expandable chamber 28 within the cavity. The expandable chamber 28 is in open communication with the input 38 via orifice 36. The accumulator 26 may not exhibit significant leaks under expected thermal and pressure conditions.

Referring to FIGS. 1 and 2, the orifice 36 may control a fill rate of the accumulator 26. The fill rate control may be required to improve on the re-pressurization time. If the fill orifice 36 is small, a rate of volume fill may be limited, and a degradation of the desired quick pressure rise may be minimized. As such, the orifice 36 restricts fuel flow so that a pressure rise time in the fuel delivery system is not substantially affected. Without this restricting orifice, the fuel pump 14 would first have to fill the volume accumulator 26 before it could build pressure in the fuel delivery system. This could be deleterious for restart times.

Still referring to FIG. 1, the accumulator 26 is shown in a “prior to key-off” state. In the “prior to key-off” state, i.e. “key-on engine running” state, the accumulator 26 may be substantially full of fuel, and the accumulator valve flexible membrane 31 is pushed toward the cover side 32. In order to avoid leakage through joints of the accumulator 26 by permeation, and in order to minimize the costs of the accumulator 26, the accumulator 26 is preferably located in the fuel tank 12 of the automotive vehicle.

Although the accumulator 26 may be embodied by several different structures, one possible version is shown in FIGS. 1 and 2. In this version, the accumulator 26 is vented to the vapor space above the fuel liquid level in the tank 12 via the vent hole 34. The vent hole 34 is designed to prevent air or vapor from being trapped between the flexible membrane 31 and the cover 32, within the accumulator 26. The vent hole 34 is further designed so as to prevent the flexible membrane 31 from extruding through. Thus, the vent hole 34 may be placed so that the flexible membrane 31 does not seal the vent hole 34 at any point of its operation. Multiple vent holes 34 are permissible. Without the vent hole 34, the fuel pressure within the accumulator 26 may prevent the accumulator 26 from performing as intended if the accumulator 26 were filled with liquid fuel (incompressible), and the accumulator 26 function may be impeded if the cavity were filled with gas (compressible). Alternately, the vent hole 34 may be large, and may not control dynamic pressures.

The orientation of the accumulator 26 may be such that trapped air is purged, i.e. air may not be trapped in high spots and the like. Thus, the fuel line's connection to the accumulator 26 may be located at or above the top of the accumulator 26. Further, all fuel lines may be slopped upward toward the fuel rail 20 or fuel manifold. In comparison to the other elements of the fuel delivery system, the flexible membrane 31, or elastomeric diaphragm, offers a large surface area within the fuel accumulator against which the fuel pressure may act. The accumulator 26 may be used in numerous fuel systems, including Return Fuel Systems (“RFS”), Mechanical Returnless Fuel Systems (“MRFS”), and Electronic Returnless Fuel Systems (“ERFS”), although ERFS systems are illustrated herein.

Now referring to FIG. 2, when the automotive vehicle is turned off and the fuel pump 14 stops, the parallel pressure relief valve (PPRV) 18 maintains pressure in the fuel rail 20. When the engine is off and the fuel rail is hot, the PPRV 18 keeps the fuel rail at a desired maximum pressure for hot restart by bleeding a relatively small amount fuel back to the tank and the accumulator element keeps the prior to key-off position at cover side (expanded volume).

As the fuel delivery system, including the fuel rail 20, cools from a maximum temperature attained and the fuel temperature, the liquid fuel volume in the fuel delivery system decreases. As a consequence, the accumulator element 30 “moves up” within the accumulator 26, i.e. up towards the orifice side (normal volume). Without the accumulator 26, a vacuum would form in the fuel delivery system, which may cause the system to refill trough the check valve within the PPRV assembly. With the accumulator 26, the fuel pressure may remain slightly positive, and thus prevents the fuel system from refilling, and the diurnal re-pressurization is prevented.

When the vehicle is in hot soak conditions, i.e. the engine is still off but the fuel rail is hot again, the fuel pressure would rise with the thermal expansion of the fuel. The rising of the fuel pressure would push the valve element to the cover side to avoid further rising of the fuel pressure. By adjusting the volume change due to the accumulator's valve element 30, a pressure rise may be limited to below a desired maximum pressure, such as 10 to 20 kPa (i.e. approximately from 0.1 to 0.2 atmospheric pressure) to minimize injector leakage.

Alternately, the flexible membrane 31 (elastomeric diaphragm) may be designed to fold (not shown) as the volume inside the accumulator 26 changes, instead of stretching or retracting. The flexible membrane 31 may fold out to accommodate a pressurized fuel system, and fold in to accommodate a fuel system at vapor pressure. The folding may be predictable and repeatable. The fuel inlet body 27 and the flexible membrane 31, and any other elements involved such as the framed portion of the flexible membrane 31, may support that the folding is performed repeatedly in the same manner and may not create stress points while subjected to repeated cycles of expected ranges of fuel and vacuum pressures.

As depicted in FIG. 3b, present day fuel delivery systems experience diurnal re-pressurization cycles, and exhibit pressure humps 48 and vacuum dips 46 during those cycles. As shown, the fuel pressure quickly rises to a positive relief pressure of 55 psi 48 (hump). When the cooling begins, the fuel pressure falls to a negative pressure relief of −2.5 psi 46 (dip). At this stage, the fuel delivery system may fill itself full of liquid or vapor. As soon as the fuel pressure increases during the diurnal heating cycle, the fuel re-pressurization reaches 55 psi 48. Further heating may cause fuel to be expulsed from the rail/line/filter system to the tank 12. Further cooling, after the system reaches −2.5 psi, may cause the system to drink liquid fuel or vaporous fuel depending on the design and fuel level in the tank 12.

In contrast, as shown in FIG. 3c, the fuel delivery system having the accumulator 26 (vacuum prevention device) does not exhibit noticeable pressure humps and vacuum dips. The pressure performance of the accumulator 26 indicates a minimal impact of the diurnal cycles on the fuel pressure of the fuel delivery system. When normally plumbed, the initial “cool down” fuel pressure characteristic is typically identical to the typical fuel delivery systems fuel pressure characteristic, as shown in FIG. 3b. However, the fuel delivery system having the accumulator 26 reduces the possibility of going into a vacuum. Thus, the fuel system does not refill itself from the tank 12. The accumulator 26 provides an expansion space for the fuel that is heated during the diurnal cycle to expand into without building significant fuel pressure. Consequently, the diurnal “humps” and “dips” are substantially minimized. Thus, the accumulator 26 minimizes fuel pressure buildup and resulting fuel leakage and evaporative emissions when the automotive vehicle is not operating.

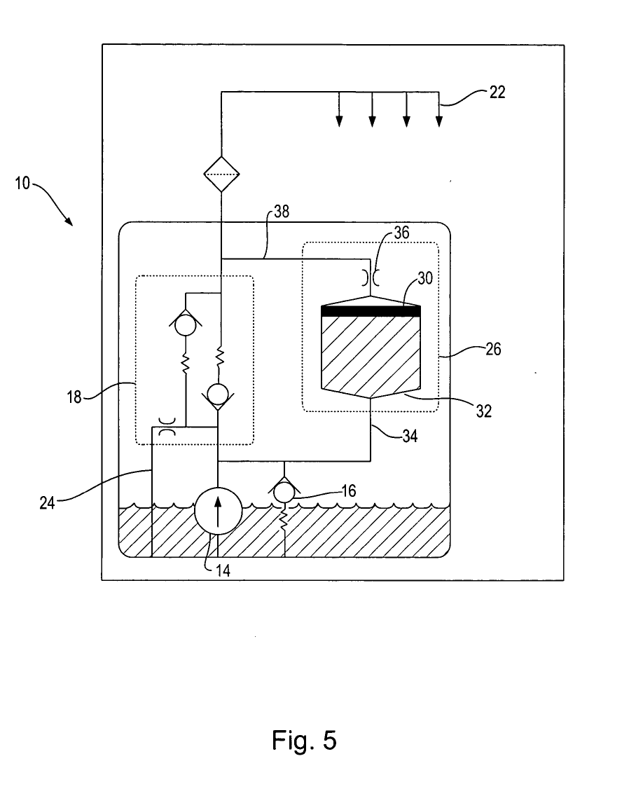

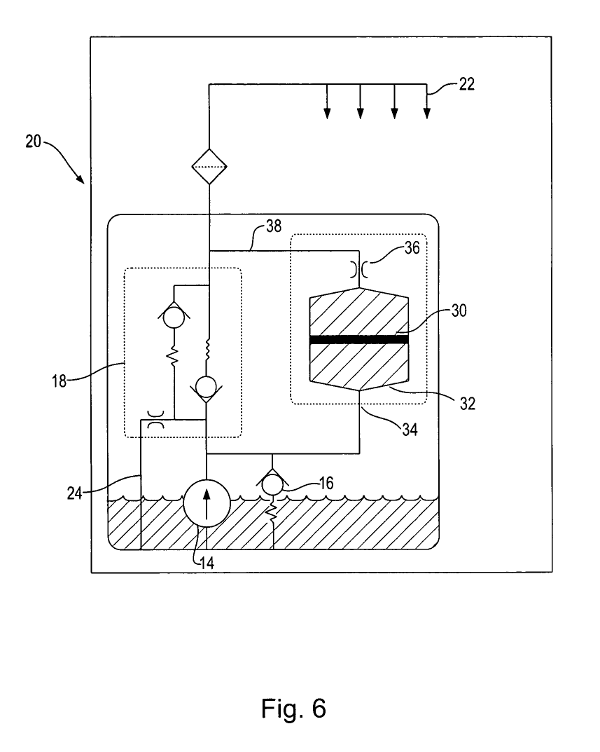

Referring to FIGS. 5 and 6, another version for the accumulator 26 may be embodied as shown. In this other version, the accumulator 26 is plumbed and is, via the bottom end of the cover 32, in further open communication with the fuel pump 14, the pump pressure relief valve 16, and the parallel pressure relief valve 18. In FIG. 5, the accumulator 26 is shown connected to the fuel pump 14 and the pump pressure relief valve 16 on one end and the fuel rail 20 on the other end. In FIG. 5, the valve element 30 position reflects a “prior to key-off” state which puts the variable fuel delivery system volume at a relatively minimum volume near the top end of the accumulator 26, rather than at a relatively maximum volume near the bottom end of the accumulator 26. Since the fuel pump pressure is at least 2.5 psi greater than rail pressure when the pump is operating, the accumulator volume may reach a minimum as shown in FIG. 5.

In FIG. 6, once the engine is off, i.e. the fuel pump 14 is turned off; the variable volume would fill to limit the fuel rail pressure to the greater of the tank pressure (near atmospheric pressure) or the fuel vapor pressure. Typically at engine key-off, the fuel continues to heat up and expand for approximately 30 minutes, because the cooling system is typically turned off. As the fuel volume expands, the pressure would continue to be limited to the greater of the tank pressure or the fuel vapor pressure. Given enough fuel cooling, the fuel delivery system may form a vacuum. Upon subsequent reheat, the diurnal pressure rise would be limited again to the greater of the tank pressure or the fuel vapor pressure. This cycle would continue until the fuel pump is again powered up.

In FIG. 3d, a pressure performance of the alternately plumbed accumulator 26 is shown. This accumulator 26 version provides for substantially fast pressure reduction after engine key-off to the fuel's vapor pressure at the corresponding fuel temperature. Thus, the fuel's vapor pressure is reduced to a vacuum's pressure. At a point where the vacuum's pressure exceeds the negative pressure relief valve setting of −2.5 psi, the vacuum's pressure is limited to −2.5 psi. Further at this stage, the fuel system drinks in fuel liquid or vapor depending on fuel delivery system configuration and fuel level in the tank 12. However, upon subsequent diurnal heating, the position of the accumulator 26 is such that the expanding fuel may flow into the accumulator 26 without building significant pressure. Another useful advantage of the alternately plumbed accumulator 26 version is that the accumulator 26 minimizes diurnal re-pressurization without submitting to an initial cooling cycle. Therefore, if a vehicle was run for only a short time duration and subsequently shut off, the fuel system may still show no diurnal humps, whereas the previously introduced accumulator version of FIGS. 1 and 2 may exhibit one initial hump. The cooling section of the initial diurnal hump may serve as a cool down cycle for repeat functioning on subsequent diurnals.

In the EFRS case, the plumbing arrangement may have yet a further advantage in that it may allow for pressure reduction by stopping the pump, even if the injectors are not operating. In present ERFS systems, should the target rail pressure be exceeded shortly after key-on, the fuel pressure may not be reduced until the injectors are operating again. As such, the fuel pressure may be too high for the first few injections. The plumbing arrangement of FIGS. 5 and 6 allow pressure reduction via stopping or slowing the fuel pump and thus an over-pressure can be reduced prior to the first injection.

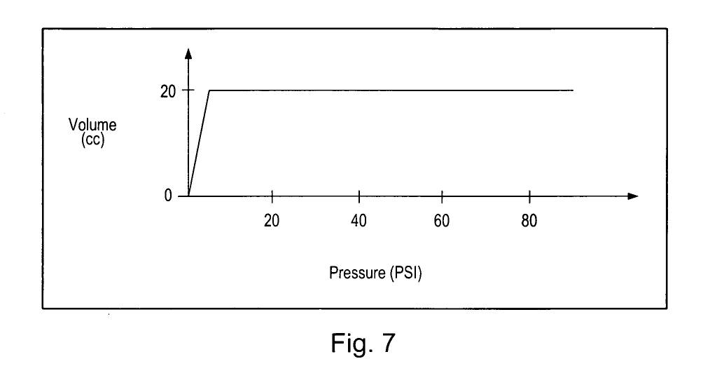

Referring now to FIG. 7, the accumulator 26 has a steady state “volume vs. pressure” characteristic as shown. As the accumulator 26 fills, the fuel pressure rises slowly until the accumulator 26 is filled. Once filled, the fuel pressure in the fuel delivery system may be limited by another component of the fuel delivery system. In a return system or an MRFS (not shown), the fuel pressure limiting component is a pressure regulator. Whereas, in an ERFS system, a reduction of pump voltage in response to sensed pressure may limit the fuel pressure at a specific set point. FIG. 7 does not provide any information for negative pressure conditions; however, the fuel volume may become slightly negative for negative pressures.

A further advantage of the volume accumulator is that it improves re-pressurization time. On a typical present design, when the fuel system cools a vapor space is created. While this vapor space exists, the fuel (trapped between the injectors and the check valve) is at its vapor pressure. If a restart occurs at this point, the re-pressurization time may be degraded because the vapor space may have to be re-filled before fuel rail pressure can build. When the volume accumulator is incorporated in the fuel delivery system, the vapor space may not be allowed to exist because it is filled with liquid fuel from the volume accumulator as quickly as it would otherwise form. Thus, especially during fuel system cooling following key-off, the volume accumulator acts to minimize the re-pressurization time.

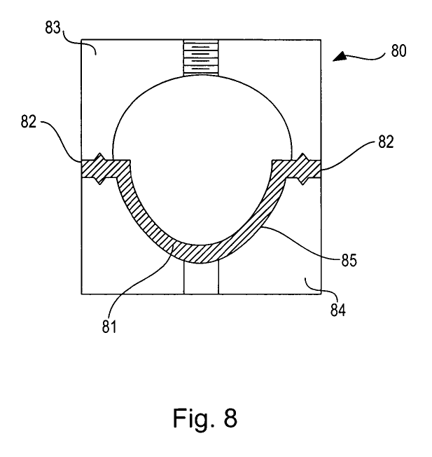

Turning now to FIGS. 8-14, various constructions of expansion/contraction tanks or accumulators that may be used as vacuum prevention devices with the present invention are shown. In FIG. 8, another embodiment of an accumulator 80 is shown. This accumulator version has a substantially circular cross section. As such, the corresponding elastomeric diaphragm 81 is dome shaped. The elastomeric diaphragm 81 is held in place by securing its circumferential end 82 between an accumulator upper block 83 and lower block 84. As shown, the dome shaped elastomeric diaphragm 81 is pushed toward the inner surface 85 of the lower block 84 and thus in a “prior to key-off” state, i.e. the accumulator 80 may be substantially full of fuel. The elastomeric diaphragm 81 may line substantially the inner surface 85 of the lower block 84 so as to prevent air or vapor from being trapped in the interface there between.

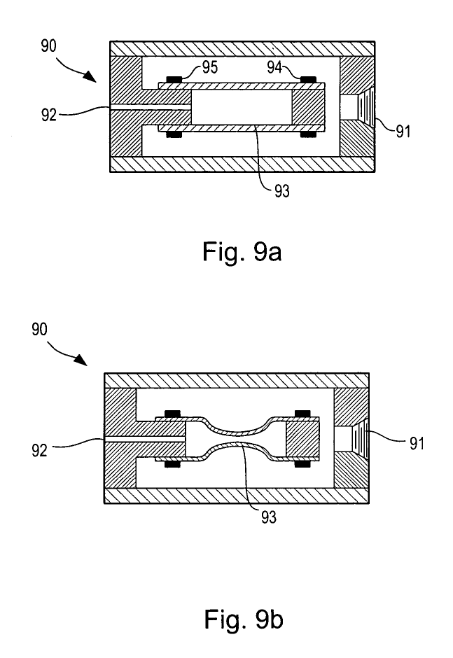

In FIGS. 9a and 9b, another embodiment of an accumulator or expansion contraction tank 90 is shown. The accumulator embodiment 90 may have a fuel inlet orifice 91 at one end, a vent hole 92 at the opposite end, and an internal flexible tube 93. The fuel orifice 91 may be connected to an input (not shown) in open communication with a fuel pump (not shown) and a fuel rail (not shown). The tube 93 is securely plugged at a first free end 94 and in open communication with the vent hole 91 at a second end 95, and securely connected to the accumulator 90. The vent hole 92 is in further open communication with the inner volume space of a fuel tank (not shown). The tube 93 may remain cylindrical during engine-on as shown in FIG. 9a, and may collapse radially as shown in FIG. 9b, during fuel cooling. Thus, the collapsible tube 93 is susceptible to an internally applied pressure.

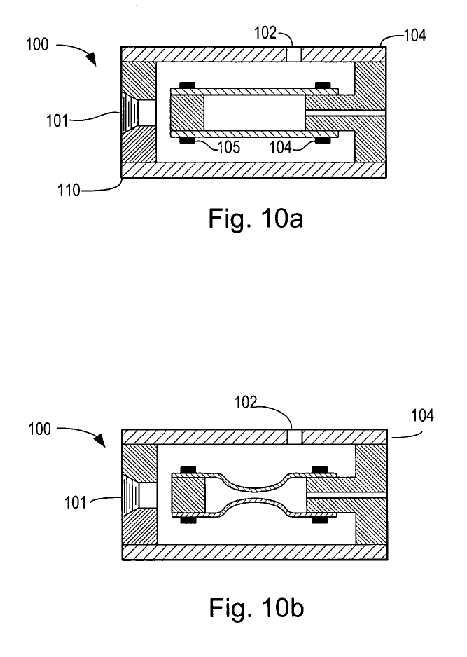

In FIGS. 10a and 10b, another embodiment of an expansion contraction tank 100 is shown. The accumulator embodiment 100 may have a fuel inlet orifice 101 at one end, a vent hole 102 at an end side, and an internal flexible tube 103. The fuel orifice 101 may be connected to a fuel input (not shown) in open communication with a fuel pump (not shown) and a fuel rail (not shown). The tube 103 is securely plugged and connected at a first end 104 to the accumulator 100, and in communication with the fuel orifice 101 at a second end 105, also secured to the accumulator 100. The vent hole 102 is in further communication with the inner volume space of a fuel tank (not shown) from a side end 104 of the accumulator 100. The tube 103 may collapse radially as shown, as the fuel pressure inside the accumulator 100 increases during engine-on as shown in FIG. 10a, and may remain cylindrical during fuel cooling as shown in FIG. 10b. As such, the collapsible tube 103 is susceptible to an externally applied pressure.

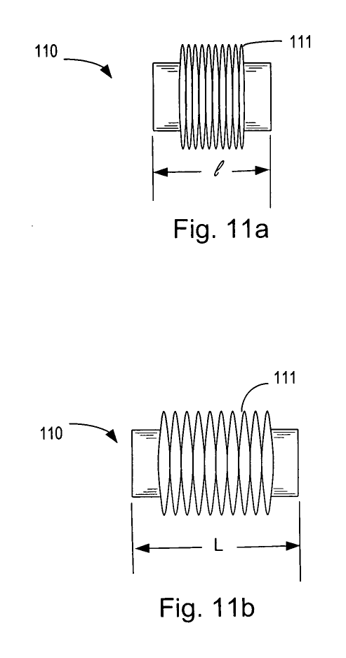

In FIGS. 11a and 11b, another version of an accumulator 110 is shown. This version is represented by an axially compressible tube 111. The compressible tube 111 compresses lengthwise, and may have a substantially accordion-like shaped middle sandwiched between two cylindrically shaped ends. Thus, the compressible tube 111 may lengthen from a compressed length “l” as an applied fuel pressure increases, and shorten from an extended length “L” as the applied fuel pressure decreases. A tube length difference between the compressed length of FIG. 11a and the extended length of FIG. 11b may be designated as a stroke. The compressible tube 111 may collapse axially as shown in FIG. 11a, as the fuel pressure inside the accumulator 110 decreases. Thus, the compressible tube 111 is susceptible to an internally applied pressure.

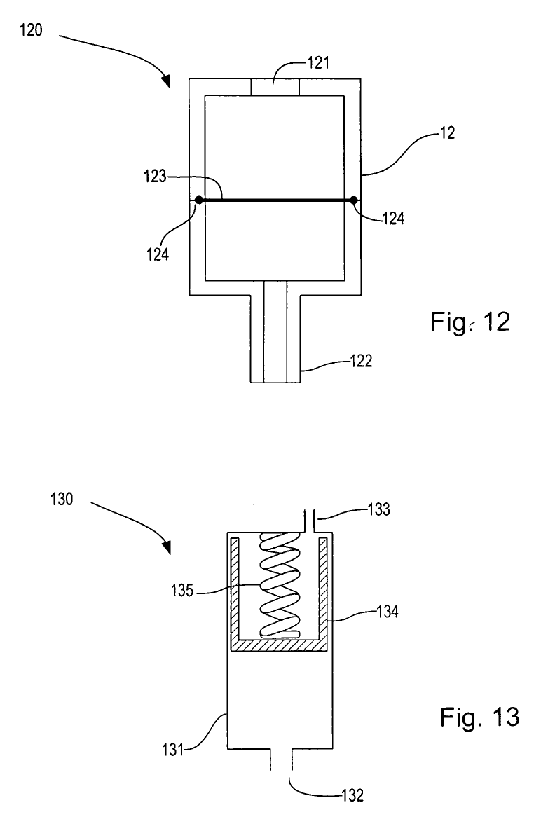

In FIG. 12, another version of an accumulator 120 is shown. This version is represented by a can-like accumulator 120. The can-like accumulator 120 may have a fuel inlet orifice 121 at one end, a vent hole 122, and an elastomeric diaphragm 123 securely captured within the accumulator 120. The elastomeric diaphragm 123 is securely attached peripherally to an axial inner surface of the accumulator 120 at circumferential ends 124. This secured attachment may constrain the elastomeric diaphragm 123 maximum extension and retraction. The diaphragm's extension and retraction may depend on material stretching instead of material bending or folding;

In FIG. 13, another version of an accumulator 130 is shown. This version, which may be realized by a variety of physical devices, is represented by a cylinder 131 having an fuel inlet orifice 132 at one end in open communication to a fuel pump (not shown) and a fuel rail (not shown), a vent hole 133 at another end in open communication with a fuel tank internal space (not shown). The accumulator further comprises a piston 134 having an outer axial surface encircled by the inner axial surface of the accumulator 130, and a spring 135 biasing the piston away from the vent hole 133. The spring 135 may be designed to provide enough force to overcome a friction force generated by piston movements within the accumulator 130. As such, the piston 134 may be pressed toward the vent hole 133 end of the accumulator 130 while biased by the spring 135 as the fuel pressure increases in the fuel delivery system. Further, the piston 134 may be drawn toward the fuel orifice 132 as the fuel pressure decreases and/or a vacuum appears in the fuel delivery system. Alternately, the spring 135 may be omitted.

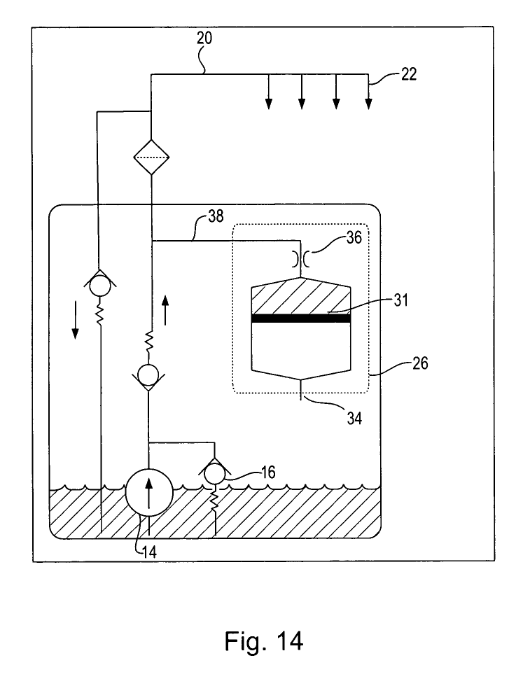

Turning now to FIG. 14, the above discussed volume accumulator 26 is shown used in a mechanical returnless fuel delivery system (MRFS), to illustrate that the present invention of a vacuum prevention device can be applied in alternate fuel systems other than an ERFS.

While a preferred embodiment of the invention has been described, it should be understood that the invention is not so limited, and modifications may be made without departing from the invention. The scope of the invention is defined by the appended claims, and all devices that come within the meaning of the claims, either literally or by equivalence, are intended to be embraced therein.

We claim:

1. A volume accumulator in a fuel delivery system comprising:
a fuel inlet body having an orifice at a first end and an open second end, and
a moving element adapted to communicate with an inner surface of the fuel inlet body situated between the first and second ends to define a fuel chamber,
wherein the fuel chamber is in open communication with the fuel delivery system via the orifice.

2. The volume accumulator of claim 1 wherein the fuel chamber is adapted to expand with substantially minimal pressure resistance until an extent of its volume is encountered

3. The volume accumulator of claim 1 wherein the fuel chamber is in open communication with a fuel pump via a check valve and a fuel rail via the orifice, the orifice substantially restricting fuel flow to substantially maintain a quick fuel rail re-pressurization.

4. The volume accumulator of claim 1 further comprises at least one seal groove on the inner surface of the inlet fuel body, and the moving element having a flexible membrane surrounded with a frame portion, wherein the frame portion is adapted to communicate with the at least one seal grove of the fuel inlet body to substantially reduce fuel leakage from the fuel chamber.

5. The volume accumulator of claim 1 wherein the flexible membrane is an elastomeric diaphragm.

6. The volume accumulator of claim 1 wherein the fuel inlet body further comprises a cover having an open top end and a bottom end, the bottom end having an open vent hole, and the open top end of the cover is adapted for securing to the open second end of the fuel inlet body for sealing purposes,

7. The volume accumulator of claim 1 is disposed in a fuel tank.

8. The volume accumulator of claim 5, wherein the open vent hole is designed to substantially reduce a trapping of air or vapor between the moving element and the cover, and expose the moving element to atmospheric pressure on the cover side.

9. The volume accumulator of claim 1, wherein prior to a key-off engine state, the moving element is pushed toward the cover while the fuel delivery system is pressurized.

10. The volume accumulator of claim 1, wherein following the key-off engine state and while the fuel rail is hot, the moving element holds the fuel rail pressure for a hot fuel rail restart.

11. The volume accumulator of claim 1, wherein the moving element moves up toward the orifice side as a fuel volume in the fuel delivery system is reduced through thermal contraction.

12. A volume accumulator in a fuel delivery system comprising:
a fuel inlet body having an orifice at a first end and an open second end,
a cover adapted for securing to the open second end of the fuel inlet body for sealing purposes, and having a bottom end, and
a moving element adapted to communicate with an inner surface of the fuel inlet body between the first end of the fuel inlet body and the cover, thereby defining two chambers,
wherein one chamber is in open communication with the fuel delivery system via the orifice upstream of a check valve, and the other chamber downstream of the check valve via the bottom end of the cover.

13. The volume accumulator of claim 12 is disposed within a fuel tank.

14. The volume accumulator of claim 12 wherein the orifice substantially restricts fuel flow so that a degradation of a substantial quick pressure rise in the fuel delivery system is substantially minimized.

15. The volume accumulator of claim 12 further comprises at least one seal grove on the inner surface of the inlet fuel body, and the moving element having a flexible membrane surrounded with a frame portion, wherein the frame portion is adapted to communicate with the at least one seal grove of the fuel inlet body to substantially reduce fuel leakage between the fuel chambers.

16. The volume accumulator of claim 12, wherein prior to a key-off engine state, the moving element is pushed toward the orifice side.

17. The volume accumulator of claim 12, wherein while a fuel rail is hot after a key-off engine state, the fuel delivery system volume expands to bring a fuel rail pressure to the greater of a fuel tank pressure or of a fuel vapor pressure.

18. The volume accumulator of claim 12, wherein a diurnal pressure rises to the greater of the fuel tank pressure or the fuel vapor pressure.

19. The volume accumulator of claim 12, wherein upon a subsequent diurnal heating, an expanding fuel flows into the accumulator reducing a substantial rise of the fuel pressure.

20. The volume accumulator of claim 12, wherein a diurnal re-pressurization of the fuel delivery system is minimized even when an initial cooling cycle is not observed.

21. A fuel delivery system for an engine, comprising:
a fuel tank containing a volume of fuel;
a fuel pump in fluid communication with said fuel tank pressurizing said fuel;
a fuel rail in fluid communication with said fuel pump via a check valve receiving said pressurized fuel;
an injector in fluid communication with said fuel rail supplying said pressurized fuel to said engine; and
a volume accumulator in fluid communication with said fuel rail and said fuel pump to substantially reduce fuel leakage through the injector.

22. The fuel delivery system of claim 21 wherein the volume accumulator comprises a fuel inlet body having an orifice at a first end and an open second end, and a moving element adapted to communicate with an inner surface of the fuel inlet body situated between the first and second ends to define a fuel chamber, wherein the fuel chamber is in open communication with the fuel delivery system via the orifice.

23. The fuel delivery system as in claim 21 wherein the volume accumulator further comprises at least one seal groove on the inner surface of the inlet fuel body, and the moving element having a flexible membrane surrounded with a frame portion, wherein the frame portion is adapted to communicate with the at least one seal grove of the fuel inlet body to substantially reduce fuel leakage.

24. The fuel delivery system of claim 21 wherein the volume accumulator comprises a fuel inlet body having an orifice at a first end and an open second end, a cover adapted for securing to the open second end of the fuel inlet body for sealing purposes, and having a bottom end, and a moving element adapted to communicate with an inner surface of the fuel inlet body between the first end of the fuel inlet body and the cover, thereby defining two chambers, wherein one chamber is in open communication with the fuel delivery system via the orifice upstream of a check valve, and the other chamber downstream of the check valve via the bottom end of the cover.

25. The fuel delivery system of claim 21, wherein during fuel system cooling following key-off the moving element holds a fuel rail pressure by reducing vapor space between the injector and the check valve so that a re-pressurization time of the fuel delivery system is substantially minimized.
